(19) United States
(12) Patent Application Publication
(10) Pub. No.: US 2025/0071147 A1
(43) Pub. Date: Feb. 27, 2025

(54) INFORMATION PROCESSING SYSTEM AND NON-TRANSITORY COMPUTER READABLE MEDIUM

(71) Applicant: FUJIFILM BUSINESS INNOVATION CORP., Tokyo (JP)

(72) Inventor: Norio YAMAMOTO, Kanagawa (JP)

(73) Assignee: FUJIFILM BUSINESS INNOVATION CORP., Tokyo (JP)

(21) Appl. No.: 18/595,892

(22) Filed: Mar. 5, 2024

(30) Foreign Application Priority Data
Aug. 24, 2023 (JP) 2023-136141

(51) Int. Cl. H04L 9/40

(52) U.S. Cl. CPC H04L 63/20; H04L 63/102

(57) ABSTRACT

An information processing system includes a processor configured to: switch, in response to an instruction from a user, between a normal use mode with security guaranteed by using a predetermined security service over Internet and a temporary use mode in which communication in a directly connected state is allowed with communications over the Internet disabled; and allow use of an external terminal device only during an operation under the temporary use mode.

### CROSS-REFERENCE TO RELATED APPLICATIONS

This application is based on and claims priority under 35 USC 119 from Japanese Patent Application No. 2023-136141 filed Aug. 24, 2023.

### BACKGROUND

### (i) Technical Field

The present disclosure relates to an information processing system and a non-transitory computer readable medium.

### (ii) Related Art

In recent years, in order to protect an in-house network established by using a LAN or the like from security threats, companies have been shifting from a boundary-based defense model using a firewall to a zero trust-based defense model using neither a LAN nor a firewall. This is because it has become more and more difficult to protect company assets with the border-based defense model due to diversified working patterns through recent introduction of remote working, shared offices, and the like.

Solutions for realizing zero trust security based on the “zero trust” concept meaning that nothing is trusted without authentication include Secure Access Service Edge (SASE), Endpoint Detection and Response (EDR), and the like. With a concept of a new security framework “SASE”, security functions and network functions in an IT environment are integrated into one cloud service. In addition, “EDR” is an endpoint security solution that collects log data from endpoints connected to a network in an organization from a cloud, detects suspicious behaviors and cyber attacks by analyzing the log data, and notifies an administrator of the suspicious behaviors and cyber attacks.

An increasing number of companies tend to use cloud services with SASE, EDR, or the like in a zero trust network access (ZTNA) environment established based on the concept of zero trust. Furthermore, in order to make a multifunction peripheral installed in the on-premise environment of a company compatible with the ZTNA environment, an agent for SASE or EDR is installed in the multifunction peripheral.

In Japanese Unexamined Patent Application Publication No. 2022-132074, a technique has been proposed in which, as one function of a multifunction peripheral that only receives data from an external device guaranteed to be safe in advance using an SSL (TLS) certificate, the multifunction peripheral transitions to a zero trust mode in which one or a plurality of network ports are forcibly blocked, a user, the external device, and the multifunction peripheral are authenticated in response to a user authentication request from the external device, and then the multifunction peripheral executes printing in response to a print request received via a network port that is not blocked under the zero trust mode. With this related art, a reliable external device is allowed to temporarily use the multifunction peripheral through various kinds of authentication.

### SUMMARY

A terminal device brought in by an outsider does not necessarily have settings for guaranteeing safety. Therefore, usually, a terminal device brought in from the outside is not allowed to use an information processing system normally operated under a mode with security guaranteed. Still, it is convenient in some cases to at least temporarily enable a terminal device for which security may not be guaranteed to use the information processing system. Examples of such a case include that where data related to collaborative development stored in a terminal device brought by a collaborative developer is desired to be shared, and the like.

Aspects of non-limiting embodiments of the present disclosure relate to enabling an information processing system that is normally operated under a mode with security guaranteed to be temporarily used by a terminal device for which security may not be guaranteed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: switch, in response to an instruction from a user, between a normal use mode with security guaranteed by using a predetermined security service over Internet and a temporary use mode in which communication in a directly connected state is allowed with communications over the Internet disabled; and allow use of an external terminal device only during an operation under the temporary use mode.

### BRIEF DESCRIPTION OF THE DRAWINGS

An exemplary embodiment of the present disclosure will be described in detail based on the following figures, wherein:

FIG. 1 is an overall configuration diagram illustrating a network system according to the present exemplary embodiment;

FIG. 2 is a diagram illustrating a difference between a zero trust mode and a guest mode in a table format in the present exemplary embodiment;

FIG. 3 is a block configuration diagram illustrating a multifunction peripheral in the present exemplary embodiment;

FIG. 4 is a diagram illustrating an example of a guest mode transition processing setting screen in the present exemplary embodiment;

FIG. 5 is a diagram illustrating an example of a zero trust mode transition processing setting screen in the present exemplary embodiment;

FIG. 6 is a flowchart illustrating mode switching processing in the present exemplary embodiment;

FIG. 7 is a diagram illustrating an example of a guest mode transition instruction screen in the present exemplary embodiment; and

FIG. 8 is a diagram illustrating an example of a zero trust mode transition instruction screen in the present exemplary embodiment.

### DETAILED DESCRIPTION

Hereinafter, a preferred exemplary embodiment of the present disclosure will be described with reference to the drawings.

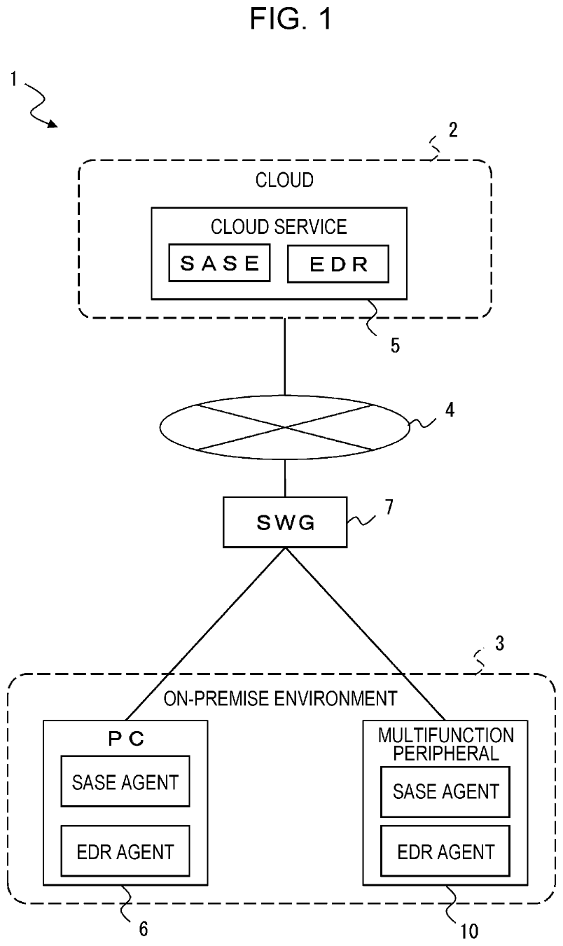

FIG. 1 is an overall configuration diagram illustrating a network system 1 according to the present exemplary embodiment. FIG. 1 illustrates a configuration in which a cloud 2 and an on-premise environment 3 are connected to each other via Internet 4. The cloud 2 provides a cloud service 5 with SASE, EDR, or the like for supporting establishment of a ZTNA environment (hereinafter, referred to as a “zero trust environment”) to a company or the like that aims to establish the zero trust environment based on the “zero trust” concept meaning that nothing is trusted without authentication.

The on-premise environment 3 is an in-house system environment of a company. In the on-premise environment 3, a PC 6 individually used by a user such as an employee and a multifunction peripheral 10 shared by users are installed. Note that although one PC 6 and one multifunction peripheral 10 are illustrated in FIG. 1, the number of these devices installed is not limited to this example, and may be any number that is one or more. The on-premise environment 3 according to the present exemplary embodiment is not provided with a firewall as illustrated in FIG. 1 in order to be adapted to the zero trust environment. Furthermore, permanent installation of LAN is avoided as much as possible. The PC 6 and the multifunction peripheral 10 are individually connected to the Internet 4 via a secure web gateway (SWG) 7. The SWG 7 is a proxy for safe access to external communications such as the Internet 4. The SWG 7 serves to protect a user from threats on the Internet 4 when the user uses a PC or the like not only in the on-premise environment 3 but also outside the on-premise environment 3 such as at home or in a shared office.

For the connection to the Internet 4, for example, a mobile data communication technology may be used. An SASE agent or an EDR agent for using the cloud service 5 with SASE, EDR, or the like is installed in the information processors such as the PC 6 or the multifunction peripheral 10 installed in the on-premise environment 3, for adaption to the zero trust environment.

The PC 6 may be implemented by a conventional general-purpose hardware configuration. That is, the PC 6 includes storage means such as a ROM, a RAM, and an HDD, user interfaces such as a mouse, a keyboard, and a touch panel, a network interface for performing data communications over the Internet 4, wireless communication means for performing near field communications using WiFi (registered trademark), BLE, or the like with another PC 6 or the multifunction peripheral 10 present in the same on-premise environment 3, and the like.

The multifunction peripheral 10 is one form of an image forming apparatus having various functions such as a print function, a copy function, and a scanner function, and having a built-in computer. The multifunction peripheral 10 according to the present exemplary embodiment may be implemented by a conventional general-purpose hardware configuration. That is, the multifunction peripheral 10 includes storage means such as a ROM, a RAM, and an HDD, a user interface such as an operation panel, a scanner or a printer for executing the above-described various functions, a network interface for performing data communications over the Internet 4, wireless communication means for performing near field communications using WiFi, BLE, or the like with the PC 6 or another multifunction peripheral 10 present in the same on-premise environment 3, and the like.

The following operation modes are prepared for the multifunction peripheral 10 according to the present exemplary embodiment: a “zero trust mode” as a normal operation mode; and a “guest mode” in which a mobile terminal device brought into the on-premise environment 3 from the outside is connected to the multifunction peripheral 10 so as to be temporarily available. Of course, other operation modes may be prepared.

The “zero trust mode” corresponds to a security mode with security guaranteed. In the multifunction peripheral 10 according to the present exemplary embodiment, the zero trust mode corresponds to an operation mode during the normal operation, that is, a normal use mode. The zero trust mode is an operation mode in which the cloud service 5 with SASE, EDR, or the like is available as a predetermined security service used over the Internet 4 in order to guarantee security.

A device having a network communication function, such as the PC 6 or the multifunction peripheral 10 illustrated in FIG. 1, generally has one or a plurality of network ports, and performs data communications with another device via a predetermined network port. Still, in the zero trust environment using no firewall, a network port kept open leads to a risk of external attack. For this reason, under the zero trust mode, control is performed for reducing the open network ports as much as possible. Thus, only the network ports used for the use of the cloud service 5 or the like are opened, for example. In other words, control for forcible blocking is performed on the network ports other than the minimum necessary network ports. Thus, under the zero trust mode, restricting the opening of the network ports is a requirement for guaranteeing security. Note that other requirements for ensuring security include installation of an SASE or an EDR agent and the like.

As described above, the “guest mode” is an operation mode in which a mobile terminal device brought into the on-premise environment 3 from the outside can be connected to the multifunction peripheral 10 to be temporarily available. The guest mode corresponds to a temporary use mode in which communication in a directly connected state is allowed with communications over the Internet 4 disabled. The guest mode enables the use of a mobile terminal device brought in from the outside, meaning that the degree of guarantee of security should not be high as compared with the zero trust mode. Still, in order to maintain security as much as possible under the zero trust environment, various contrivances are made for environment settings.

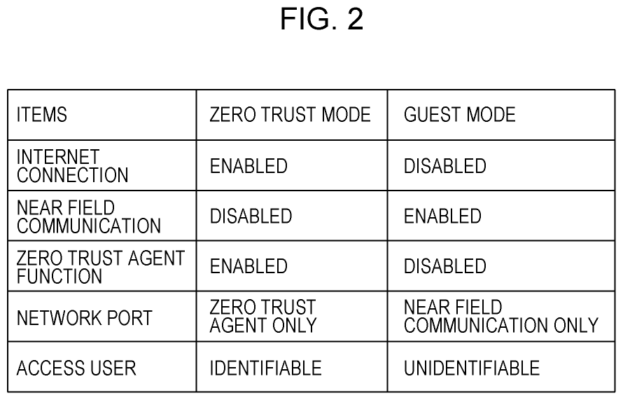

Now, a comparison is made between the operation modes, that is, the zero trust mode and the guest mode. The difference between the operation modes is illustrated in FIG. 2. It should be noted that, in the present exemplary embodiment, “deactivate”, “disable”, “prohibit”, and the like refer to states in which the functions cannot be exhibited, and all of them mean a “disabled” state. On the other hand, “start”, “enable”, “allow”, and the like refer to states in which the functions can be executed, and all of them mean an “enabled” state.

To begin with, connection to the Internet 4 is enabled under the zero trust mode, because the cloud service 5 with SASE, EDR, or the like or an Identity Provider (IdP) needs to be used for guaranteeing security. On the other hand, under the guest mode, connection to the Internet 4 is disabled in order to prevent information leakage or the like to the outside during use of a mobile terminal device brought in by a third party.

Near field communications are disabled under the zero trust mode, in order to more consistently guarantee security. In the present exemplary embodiment, the near field communications are assumed to be wireless communications by wireless LAN connection using WiFi Direct (registered trademark) (hereinafter, simply referred to as “WiFi connection”) or short-range wireless communication by Bluetooth (registered trademark) Low Energy (BLE). Of course, if the multifunction peripheral 10 can use other wireless communication functions, such functions are also included. On the other hand, under the guest mode, near field communications are enabled for realizing connection with a mobile terminal device brought in by a third party.

A zero trust agent function is active under the zero trust mode for guaranteeing security, but is inactive under the guest mode since the cloud service 5 cannot be used over the Internet 4.

Under the zero trust mode and the guest mode, the minimum necessary network ports required for data communications are open and the other network ports are blocked.

Under the zero trust mode, the IdP can be used over the Internet 4, and thus it is possible to identify which user has accessed what. On the other hand, under the guest mode, since the cloud service 5 cannot be used over the Internet 4, basically, it is not possible to identify who has accessed what.

Note that the above comparison between the operation modes corresponds to the current technology for establishing the zero trust environment, and there may be a change driven by the development of the technology in the future. For example, improvement in the function of the SASE or EDR agent may enable the use of the zero trust agent function also under the guest mode. Furthermore, improvement in security may lead to the near field communications allowed under the zero trust mode. As described above, the difference in the setting items between the operation modes is not limited to that described above. FIG. 2 illustrates items related to the description of the present exemplary embodiment, and the same does not apply to the other items not illustrated in FIG. 2.

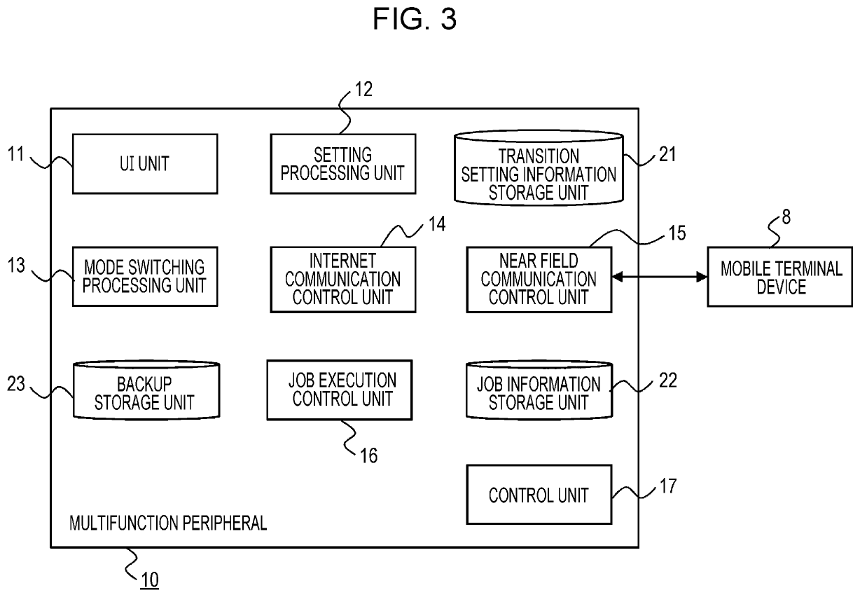

FIG. 3 is a block configuration diagram illustrating the multifunction peripheral 10 according to the present exemplary embodiment. The multifunction peripheral 10 includes a user interface (UI) unit 11, a setting processing unit 12, a mode switching processing unit 13, an Internet communication control unit 14, a near field communication control unit 15, a job execution control unit 16, a control unit 17, a transition setting information storage unit 21, a job information storage unit 22, and a backup storage unit 23. Note that components not used in the description of the present exemplary embodiment are omitted in the drawings.

The user interface unit 11 receives a user input on an operation panel, and performs display on the operation panel. The setting processing unit 12 sets processing to be executed at the time of transition of each operation mode in response to an instruction from a user such as an administrator. The content set by the setting processing unit 12 is saved in the transition setting information storage unit 21 as transition setting information. The mode switching processing unit 13 switches the operation mode of the multifunction peripheral 10 in response to an instruction from a user of the multifunction peripheral 10. In the case of the present exemplary embodiment, the switching is performed between the zero trust mode and the guest mode. The Internet communication control unit 14 performs communication control such as switching between the enabling and disabling of data communications over the Internet 4. The near field communication control unit 15 performs communication control such as switching between the enabling and disabling of data communications using short-range wireless communication means. The near field communication control unit 15 according to the present exemplary embodiment is assumed to perform communication control to be executed by establishing WiFi connection with a mobile terminal device 8 brought in by an outsider.

The job execution control unit 16 controls execution of a job sent to the multifunction peripheral 10. The job information storage unit 22 stores the sent job, job log, and the like. The control unit 17 controls operation of the components 11 to 16 described above. The backup storage unit 23 stores a backup file generated at the time of transition to the guest mode.

Each of the components 11 to 17 in the multifunction peripheral 10 is implemented by a cooperative operation of a computer provided in the multifunction peripheral 10 and a program operated by a CPU provided in the computer. Furthermore, each of the storage units 21 to 23 is implemented by an HDD provided in the multifunction peripheral 10. Alternatively, a RAM may be used or, if possible, external storage means may be used via a network.

A program used in the present exemplary embodiment can be not only provided by communication means, but also provided by being stored in a computer-readable recording medium such as a USB memory. The programs provided from the communication means or the recording medium are installed in the computer, and the CPU of the computer sequentially executes the programs to implement various kinds of processing.

The “information processing system” is assumed to be configured by one multifunction peripheral 10 in the present exemplary embodiment as an example, but may be configured by a plurality of devices.

Next, an operation in the present exemplary embodiment will be described.

In the present exemplary embodiment, the operation mode of the multifunction peripheral 10 is set to the zero trust mode or the guest mode for operation according to the purpose of use. In the present exemplary embodiment, the operation mode is switched in response to an operation instruction from the user.

Note that in the present exemplary embodiment, in which two kinds of operation modes are prepared, “switching” the operation mode to the zero trust mode or the guest mode is synonymous with “transition” from one operation mode to another operation mode, that is, from the zero trust mode to the guest mode, or from the guest mode to the zero trust mode.

In the present exemplary embodiment, processes to be executed for transition of the operation mode to another operation mode are set in advance by an administrator or the like.

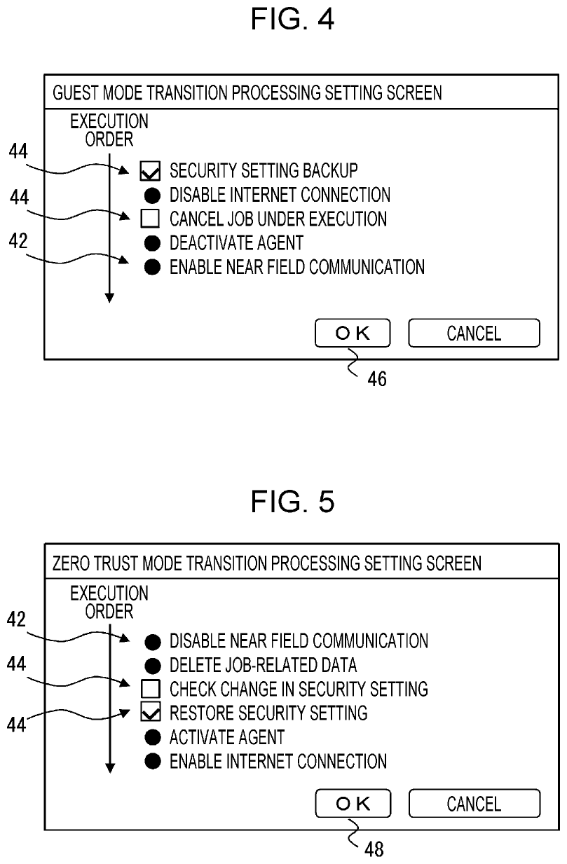

FIG. 4 is a diagram illustrating an example of a guest mode transition processing setting screen in the present exemplary embodiment. The setting processing unit 12 displays the guest mode transition processing setting screen on the operation panel in response to a predetermined operation by the administrator. To be precise, the user interface unit 11 receives an operation performed on the operation panel by the administrator, acquires the guest mode transition processing setting screen to be displayed in response to the operation from the setting processing unit 12, and displays the guest mode transition processing setting screen on the operation panel. However, in the present exemplary embodiment, for convenience of description, the operation of the user interface unit 11 is omitted.

On the guest mode transition processing setting screen illustrated in FIG. 4, processes to be executed in the processing of transition from the zero trust mode to the guest mode are displayed according to the order of execution of the processes. Among the processes to be executed, “disable Internet connection”, “deactivate agent”, and “enable near field communication” corresponding to black dots 42 are essential processes to be always executed at the time of transition to the guest mode. On the other hand, “security setting backup” and “cancel job under execution”, which are displayed in association with check boxes 44, are additional processes. In the present exemplary embodiment, the administrator checks the check boxes 44 to select execution targets. The check boxes 44 on the guest mode transition processing setting screen illustrated in FIG. 4 correspond to an example where “security setting backup” is selected and “cancel job under execution” is not selected. Note that the detailed description of the processes will be given together with the description of the operation.

After setting the processes to be execution targets on the guest mode transition processing setting screen, the administrator selects an OK button 46. In response to the selection of the OK button 46, the setting processing unit 12 stores the contents set on the guest mode transition processing setting screen in the transition setting information storage unit 21 as guest mode transition setting information.

FIG. 5 is a view illustrating an example of a zero trust mode transition processing setting screen in the present exemplary embodiment. The setting processing unit 12 displays the zero trust mode transition processing setting screen on the operation panel in response to a predetermined operation by the administrator.

On the zero trust mode transition processing setting screen illustrated in FIG. 5, processes to be executed in the processing of transition from the guest mode to the zero trust mode are displayed according to the order of execution of the processes. Among the processes to be executed, “disable near field communication”, “delete job-related data”, “activate agent”, and “enable Internet connection” corresponding to the black dots 42 are essential processes to be always executed at the time of transition to the zero trust mode. On the other hand, “check change in security setting” and “restore security setting”, which are displayed in association with the check boxes 44, are additional processes. The check boxes 44 on the zero trust mode transition processing setting screen illustrated in FIG. 5 correspond to an example where “restore security setting” is selected by the administrator, and “check change in security setting” is not selected by the administrator. Note that the detailed description of the processes will be given together with the description of the operation.

Note that in the present exemplary embodiment, the check boxes 44 are associated with some processes so that the administrator can select processes to be executed at the time of transition of the operation mode, but the processing is not necessarily performed so as to be selected, and may be automatically performed like the processes corresponding to the black dots 42.

After setting the processes to be execution targets on the zero trust mode transition processing setting screen, the administrator selects an OK button 48. In response to the selection of the OK button 48, the setting processing unit 12 stores the contents set on the zero trust mode transition processing setting screen in the transition setting information storage unit 21 as zero trust mode transition setting information.

As is clear from reference to the respective setting screens illustrated in FIG. 4 and FIG. 5, the processes executed in the zero trust mode transition processing are basically paired with the processes executed in the guest mode transition processing, to restore the setting for enabling/disabling activating/deactivating in the guest mode transition processing. Furthermore, the order of the processes executed in the zero trust mode transition processing is basically opposite to the order of the processes executed in the guest mode transition processing.

Note that the above-described configuration of the processes executed at the time of mode transition is merely an example, and should not necessarily be construed in a limiting sense. For example, the configuration may be made in accordance with the setting content at the time of establishing the zero trust environment in the future.

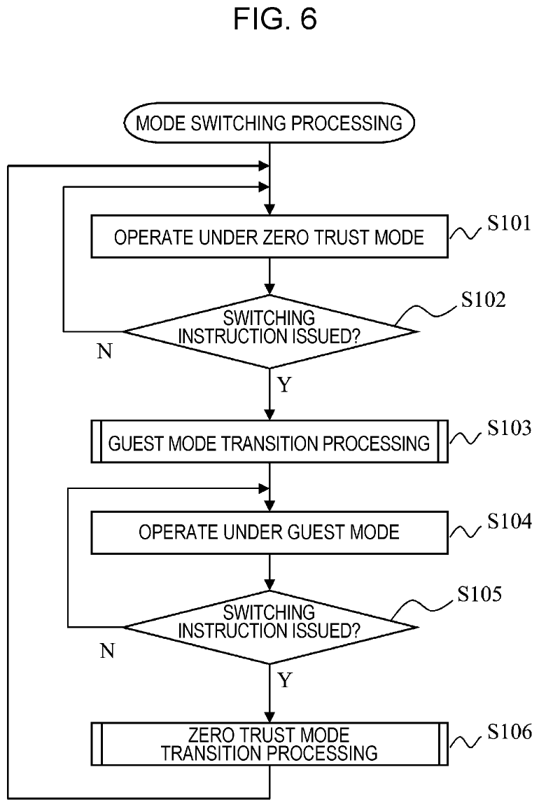

Next, the mode switching processing in the present exemplary embodiment will be described with reference to the flowchart illustrated in FIG. 6.

The execution of the mode switching processing in the present exemplary embodiment starts in response to the activation of the multifunction peripheral 10, and the mode switching processing is constantly executed while the multifunction peripheral 10 is in operation. Furthermore, the multifunction peripheral 10 according to the present exemplary embodiment operates and is managed under the zero trust mode during the normal operation (step S101). That is, the multifunction peripheral 10 is in a state with security guaranteed. Specifically, the SASE or EDR agent installed in the multifunction peripheral 10 effectively operates, and performs the soundness management or the like for the multifunction peripheral 10 in a state where the cloud service 5 with SASE or EDR can be used over the Internet 4. Furthermore, the multifunction peripheral 10 can perform user authentication by using the IdP that is accessible over the Internet 4. Furthermore, since the SASE or EDR agent is installed in an information processor that can use the multifunction peripheral 10 over the Internet 4, security can be maintained. The multifunction peripheral 10 is in a state in which the multifunction peripheral 10 can execute the job sent thereto, under such a zero trust environment that can prevent and detect unauthorized access. On the other hand, the multifunction peripheral 10 disables the near field communication function to prohibit communications with devices directly connected to the multifunction peripheral 10.

The operation under the zero trust mode described above continues until a mode switching instruction is given from the user (N in step S102).

Here, when a user who has brought the mobile terminal device 8 wants to use the multifunction peripheral 10, the user operates the operation panel to display a guest mode transition instruction screen. It is assumed that the SASE or EDR agent is not installed in the mobile terminal device 8.

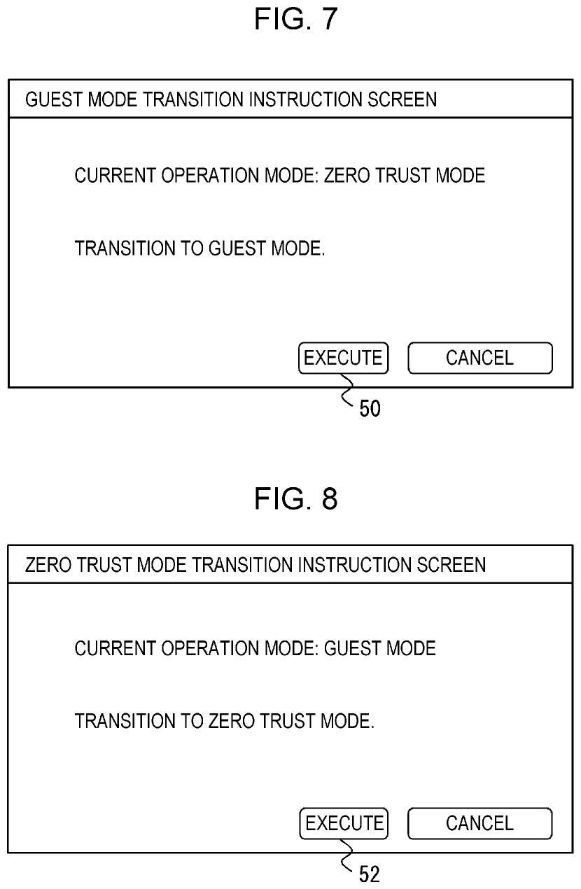

FIG. 7 is a diagram illustrating an example of the guest mode transition instruction screen in the present exemplary embodiment. By referring to the guest mode transition instruction screen, the user recognizes that the multifunction peripheral 10 is currently operating under the zero trust mode, and if the user wants to make a transition from the zero trust mode to the guest mode, the user selects an execution button 50.

The user interface unit 11 receives the selection of the execution button 50 on the guest mode transition instruction screen as a mode switching instruction. In this way, when the mode switching instruction is issued from the user (Y in step S102), the mode switching processing unit 13 executes the guest mode transition processing described below (step S103). That is, the mode switching processing unit 13 reads the guest mode transition setting information stored in the transition setting information storage unit 21, and executes the guest mode transition processing according to the read guest mode transition setting information.

Referring to the setting example based on the display content on the guest mode transition processing setting screen illustrated in FIG. 4 as the guest mode transition setting information, the mode switching processing unit 13 first performs the security setting backup selected as an option. That is, the mode switching processing unit 13 acquires information on security currently set for the multifunction peripheral 10, generates a backup file, and stores the backup file in the backup storage unit 23.

In the present exemplary embodiment, the setting content to be backed up in the multifunction peripheral 10 is limited to the information related to the security for the sake of maintenance of the security guaranteed, but such a limitation may be lifted, and the information related to an attribute other than the security may be included, or all the settings for the multifunction peripheral 10 may be backed up.

Next, the mode switching processing unit 13 performs disconnection from the Internet 4 to stop the data communication over the Internet 4. As a result, the multifunction peripheral 10 can no longer use the cloud service 5 using the SASE or EDR agent. Therefore, the mode switching processing unit 13 subsequently deactivates the agent. Finally, the mode switching processing unit 13 enables near field communications that are currently disabled.

When the execution of the guest mode transition processing in the mode switching processing unit 13 is finished, the multifunction peripheral 10 transitions to the guest mode, and the operation starts under the guest mode (step S104).

Note that while it is assumed that the mode transitions from the zero trust mode to the guest mode when the execution of the guest mode transition processing is finished, reboot may occur as necessary after the transition processing. Further, the current operation mode may be managed using flag data or the like. In this case, when the mode switching processing unit 13 finishes the execution of the last process, the control unit 17 may update the setting of the flag information for the mode management to notify other functions or other devices of the multifunction peripheral 10, of the current operation mode being the guest mode.

Now, a case is described where “cancel job under execution” is selected, even though “cancel job under execution” is not executed in the guest mode transition processing according to the guest mode transition processing setting screen illustrated as an example in FIG. 4.

The multifunction peripheral 10 executes the job accepted during the operation under the zero trust mode, but in a case where there is a job under execution when the mode switching instruction is received, the multifunction peripheral 10 can make a setting on how such a job under execution should be handled. That is, in a case where “cancel job under execution” is selected, if there is a job under execution, the mode switching processing unit 13 causes the job execution control unit 16 to forcibly cancel the job. Thus, the job under execution is controlled so as not to be executed in both the zero trust mode and the guest mode. When a job being executed during the operation under the zero trust mode continues to be executed under the guest mode, there is a risk in that the job under execution is altered with malicious intent during the operation under the guest mode. By preventing such a fraudulent act in advance, it is possible to prevent leakage of information held by the multifunction peripheral 10 in advance.

On the other hand, in a case where “cancel job under execution” is not selected, when there is a job under execution, the control unit 17 waits until the execution of the job ends without causing the job execution control unit 16 to forcibly cancel the job, and makes the operation mode transition from the zero trust mode to the guest mode after confirming the end of the execution of the job. Alternatively, the control unit 17 may perform control to implement the transition to the guest mode after waiting for the end of a process over the Internet 4 in the job, instead of the end of the job under execution. This is because the process over the Internet 4 may be non-cancelable before its completion, or a correct execution result of the job may fail to be obtained if the process over the Internet 4 is cancelled before its completion.

As described above, in order to perform control to prevent the job under execution from being executed in both the zero trust mode and the guest mode, the control unit 17 performs control to forcibly terminate the job under execution or to transition to the guest mode after the execution of the job is finished.

Alternatively, instead of controlling the execution of the job under execution as described above, the control unit 17 may perform control to stop the transition to the guest mode when there is a job under execution. When there is no job under execution, the control unit 17 does not need to perform special job-related control.

As described above, when the operation mode of the multifunction peripheral 10 is switched to the guest mode, the multifunction peripheral 10 is not allowed to perform data communications over the Internet 4, and thus cannot use the cloud service 5 with SASE or EDR. On the other hand, the near field communication function is enabled. Therefore, the user performs a predetermined operation on the mobile terminal device 8 to establish a WiFi connection between the mobile terminal device 8 and the multifunction peripheral 10. This connection may be established by a conventional method. When the mobile terminal device 8 is directly connected to the multifunction peripheral 10, the user can use the multifunction peripheral 10. For example, the user can transmit a job such as printing from the mobile terminal device 8 to the multifunction peripheral 10 to execute the job. The operation under the guest mode continues as long as a mode switching instruction is not issued from the user (N in step S105).

Here, when a user such as an outsider who has brought the mobile terminal device 8 finishes using the multifunction peripheral 10, the user operates the operation panel to display a zero trust mode transition instruction screen.

FIG. 8 is a diagram illustrating an example of the zero trust mode transition instruction screen in the present exemplary embodiment. By referring to the zero trust mode transition instruction screen, the user recognizes that the multifunction peripheral 10 is currently operating under the guest mode, and if the user wants to make a transition from the guest mode to the zero trust mode, the user selects an execution button 52.

The user interface unit 11 receives the selection of the execution button 52 on the zero trust mode transition instruction screen as a mode switching instruction. In this way, when the mode switching instruction is issued from the user (Y in step S105), the mode switching processing unit 13 executes the zero trust mode transition processing described below (step S106). That is, the mode switching processing unit 13 reads the zero trust mode transition setting information stored in the transition setting information storage unit 21, and executes the zero trust mode transition processing according to the read zero trust mode transition setting information.

Referring to the setting example based on the display content of the zero trust mode transition processing setting screen illustrated in FIG. 5 as the zero trust mode transition setting information, the mode switching processing unit 13 first disables the near field communications currently enabled.

Subsequently, the mode switching processing unit 13 deletes, as job-related data, a job generated during operation under the guest mode, data generated by execution of the job, and the like. This is for preventing in advance destruction of information held in the multifunction peripheral 10, the leakage of information over the Internet 4 to which connection is established after the transition to the zero trust mode, or the like in a case where data to be left in the multifunction peripheral 10 is an unauthorized application or the like. A log or the like generated through the normal use of a function of the multifunction peripheral 10 may not be deleted.

In the present exemplary embodiment, the data to be deleted is limited to the data related to the job, but such limitation may be lifted, and all the data generated during the operation under the guest mode, i.e., after the transition from the zero trust mode to the guest mode and before the transition to the zero trust mode again may be deleted.

Subsequently, the mode switching processing unit 13 performs security setting restoration selected as an option. That is, the mode switching processing unit 13 retrieves and restores the backup file generated at the time of transition to the guest mode and stored in the backup storage unit 23. Thus, even if the security-related information is rewritten during the operation under the guest mode, the rewritten content can be restored to the setting before the transition to the guest mode, that is, during the operation under the immediately preceding zero trust mode without being reflected in the operation under the zero trust mode after the transition. Thus, it is possible to avoid the influence of the content whose setting has been changed during the operation under the guest mode. Since the backup file includes at least information related to security for the sake of maintenance of the security guaranteed, at least a state with security guaranteed is ensured after the transition to the operation under the zero trust mode.

Subsequently, the mode switching processing unit 13 activates the agent. Finally, the mode switching processing unit 13 enables the connection to the Internet 4, thereby enabling data communication over the Internet 4. Thus, the multifunction peripheral 10 becomes able to use the cloud service 5 using the SASE or EDR agent activated, and a state with security guaranteed is restored.

When the execution of the zero trust mode transition processing in the mode switching processing unit 13 is finished, the multifunction peripheral 10 transitions to the zero trust mode, and the operation under the zero trust mode starts (step S101). When the mode switching processing unit 13 finishes the execution of the last process, the control unit 17 may update the setting of the above-described flag information for the mode management to notify other functions or other devices of the multifunction peripheral 10, of the current operation mode being the zero trust mode.

Now, a case is described where “check change in security setting” is selected, even though “check change in security setting” is not executed in the zero trust mode transition processing according to the zero trust mode transition processing setting screen illustrated as an example in FIG. 5.

Similarly to the above-described “restore security setting”, “check change in security setting” is a process for preventing a change in the setting content made during the operation under the guest mode from being reflected on the operation under the zero trust mode after the transition. In addition, as in the case of the above-described “restore security setting”, the backup file generated at the time of the guest mode transition processing is also required in this process. In other words, unless “security setting backup” is selected on the guest mode transition processing setting screen, “check change in security setting” and “restore security setting” are processes that cannot be executed.

Similarly to the backup of the security setting at the time of the guest mode transition processing, the mode switching processing unit 13 backs up the security setting under the current guest mode, in other words, the security setting before the transition to the zero trust mode. Next, the mode switching processing unit 13 checks the backup file thus acquired with the backup file stored in the backup storage unit 23. In a case where there is a difference in the setting content of the multifunction peripheral 10 between before and after the operation under the guest mode, in other words, in a case where there is inconsistent information, the mode switching processing unit 13 executes a predetermined process. As the predetermined process, the mode switching processing unit 13 extracts, for example, inconsistent information and displays the information in the form of a list on the operation panel. Alternatively, the information may be written and saved in a log file. In this way, the administrator is notified of the difference in the setting content of the multifunction peripheral 10 between before and after the operation under the guest mode. The administrator can check the item whose setting value has been changed by referring to the operation panel or the log file. If the change in the setting value has been fraudulently made, the fraud can be recognized. Alternatively, the mode switching processing unit 13 may stop the transition to the zero trust mode as the predetermined process. As a result, it is possible to prevent in advance a failure to operate normally after the transition to the zero trust mode. In this case, the administrator needs to take some measures for the transition to the zero trust mode.

During the operation under the guest mode, the cloud service 5 with SASE or the like is not available and thus the multifunction peripheral 10 does not correspond to the zero trust environment. Such a situation cannot be regarded as a state with security sufficiently guaranteed. Still, such a situation is free of attack over the Internet 4. Since only access from the mobile terminal device 8 is accepted, if any fraud is detected, it can be estimated to be a fraud using the mobile terminal device 8.

In a case where the administrator selects “restore security setting”, the state at the time of the operation under the zero trust mode immediately before the transition to the guest mode is unconditionally restored. Therefore, even in a case where the setting content is changed during the operation under the guest mode, such a change imposes no influence at all. Still, the change in the setting content made during the operation under the guest mode is not detected. Thus, whether a change is made cannot be detected.

On the other hand, when the administrator selects “check change in security setting”, a change in the setting content made during the operation under the guest mode can be detected, and the content, that is, the setting values before and after the change can also be checked. However, regardless of whether the changed setting content is reflected at the time of operation under the zero trust mode or the original setting content is restored without reflecting the changed setting content, it is necessary to take some measures before transition to the zero trust mode.

According to the present exemplary embodiment, even an outsider can temporarily use the multifunction peripheral 10 by allowing the multifunction peripheral 10 to operate under the guest mode. Under the guest mode, the security is maintained as much as possible, by accepting and executing only a job from the mobile terminal device 8 directly connected to the multifunction peripheral 10, disabling connection to the Internet 4, and the like. Still, as described above, the on-premise environment 3 is not a zero trust environment during the operation under the guest mode. Therefore, reliable defense against fraud performed by the user of the mobile terminal device 8 may fail to be achieved.

In view of this, in the present exemplary embodiment, the function of deleting the data generated during the operation under the guest mode, the function of restoring the backup file generated during the operation under the zero trust mode to restore the original setting, and the function of detecting a change made in the setting of the multifunction peripheral 10 are provided before the transition from the guest mode to the zero trust mode. Thus, the information generated and the setting changed during the operation under the guest mode can be prevented from being reflected under the zero trust mode. As a result, under the zero trust mode, a state with security guaranteed can be firmly maintained.

In the above exemplary embodiment, the processor refers to a processor in a broad sense, and includes a general-purpose processor (such as, for example, a central processing unit (CPU)) and a dedicated processor (such as, for example, a graphics processing unit (GPU), an application specific integrated circuit (ASIC), a field programmable gate array (FPGA), or a programmable logic device).

The operation of the processor in the above-described exemplary embodiment may be performed not only by one processor but also by a plurality of processors located at physically separated positions and cooperating with each other. Furthermore, the order of the operations of the processor is not limited to the order described in the above exemplary embodiment only, and may be appropriately changed.

### APPENDIX

(((1)))

An information processing system comprising: a processor configured to:
switch, in response to an instruction from a user, between a normal use mode with security guaranteed by using a predetermined security service over Internet and a temporary use mode in which communication in a directly connected state is allowed with communications over the Internet disabled, and
allow use of an external terminal device only during an operation under the temporary use mode.
(((2)))

The information processing system according to (((1))), wherein the information processing system transitions to the temporary use mode after the processor backs up a setting content of the information processing system during an operation under the normal use mode.
(((3)))

The information processing system according to (((1)) or (((2))), wherein, when the information processing system transitions from the temporary use mode to the normal use mode, the processor is configured to perform a process to prevent a change in a setting content made under the temporary use mode from being reflected under the normal use mode.
(((4)))

The information processing system according to (((3))), wherein, when the information processing system transitions from the temporary use mode to the normal use mode, the processor is configured to restore the backed-up setting content in the information processing system and then starts the operation under the normal use mode.
(((5)))

The information processing system according to (((3))), wherein, when the information processing system transitions from the temporary use mode to the normal use mode, the processor is configured to execute a predetermined process in a case where the setting content of the information processing system operating under the temporary use mode is different from the backed-up setting content.
(((6)))

The information processing system according to (((5))), wherein the predetermined process is a process of issuing a notification to an administrator.
(((7)))

The information processing system according to (((5))), wherein the predetermined process is a process of stopping the transition to the normal use mode.
(((8)))

The information processing system according to any one of (((1))) to (((7))), wherein, in a case where there is a job under execution when the information processing system transitions from the normal use mode to the temporary use mode, the processor is configured to perform control to prevent the job from being executed in both the normal use mode and the temporary use mode.
(((9)))

The information processing system according to (((8))), wherein the processor is configured to perform control to implement the transition to the temporary use mode after waiting for end of the job under execution or end of a process performed over the Internet in the job.
(((10)))

The information processing system according to (((8))), wherein the processor is configured to perform control to stop the transition to the temporary use mode.
(((11)))

The information processing system according to (((8))), wherein the processor is configured to forcibly terminate the job under execution.
(((12)))

The information processing system according to any one of (((1))) to (((11))), wherein, when the information processing system transitions from the temporary use mode to the normal use mode, the processor is configured to delete data generated during the operation under the temporary use mode.
(((13)))

A program causing a computer to execute a process comprising:
switching, in response to an instruction from a user, between a normal use mode with security guaranteed by using a predetermined security service over the Internet and a temporary use mode in which communication in a directly connected state is allowed with communications over the Internet disabled; and
allowing use of an external terminal device only during an operation under the temporary use mode.

What is claimed is:

1. An information processing system comprising:
a processor configured to:
switch, in response to an instruction from a user, between a normal use mode with security guaranteed by using a predetermined security service over Internet and a temporary use mode in which communication in a directly connected state is allowed with communications over the Internet disabled; and
allow use of an external terminal device only during an operation under the temporary use mode.

2. The information processing system according to claim 1, wherein the information processing system transitions to the temporary use mode after the processor backs up a setting content of the information processing system during an operation under the normal use mode.

3. The information processing system according to claim 2, wherein, when the information processing system transitions from the temporary use mode to the normal use mode, the processor is configured to perform a process to prevent a change in a setting content made under the temporary use mode from being reflected under the normal use mode.

4. The information processing system according to claim 3, wherein, when the information processing system transitions from the temporary use mode to the normal use mode, the processor is configured to restore the backed-up setting content in the information processing system and then starts the operation under the normal use mode.

5. The information processing system according to claim 3, wherein, when the information processing system transitions from the temporary use mode to the normal use mode, the processor is configured to execute a predetermined process in a case where the setting content of the information processing system operating under the temporary use mode is different from the backed-up setting content.

6. The information processing system according to claim 5, wherein the predetermined process is a process of issuing a notification to an administrator.

7. The information processing system according to claim 5, wherein the predetermined process is a process of stopping the transition to the normal use mode.

8. The information processing system according to claim 1, wherein, in a case where there is a job under execution when the information processing system transitions from the normal use mode to the temporary use mode, the processor is configured to perform control to prevent the job from being executed in both the normal use mode and the temporary use mode.

9. The information processing system according to claim 8, wherein the processor is configured to perform control to implement the transition to the temporary use mode after waiting for end of the job under execution or end of a process performed over the Internet in the job.

10. The information processing system according to claim 8, wherein the processor is configured to perform control to stop the transition to the temporary use mode.

11. The information processing system according to claim 8, wherein the processor is configured to forcibly terminate the job under execution.

12. The information processing system according to claim 1, wherein, when the information processing system transitions from the temporary use mode to the normal use mode, the processor is configured to delete data generated during the operation under the temporary use mode.

13. A non-transitory computer readable medium storing a program causing a computer to execute a process comprising:
switching, in response to an instruction from a user, between a normal use mode with security guaranteed by using a predetermined security service over the Internet and a temporary use mode in which communication in a directly connected state is allowed with communications over the Internet disabled; and
allowing use of an external terminal device only during an operation under the temporary use mode.
